(19) United States
(12) Patent Application Publication
(10) Pub. No.: US 2012/0074019 A1
(43) Pub. Date: Mar. 29, 2012

(54) USE OF PVA STRIPS FOR ATTACHING AN OBJECT TO A DISPLAY BACKER

(76) Inventors: Matteo Visentin, London (GB); Lysa Marie Clavenna, London (GB)

(21) Appl. No.: 12/892,699

(22) Filed: Sep. 28, 2010

(51) Int. Cl. B65D 73/00; B29C 65/56; B29C 53/36

(52) U.S. Cl. 206/460; 156/217; 156/703

(57) ABSTRACT

Strips of soluble PVA can be used to attach an object to a display backer (e.g. cardboard). A wet or uncured strip of soluble PVA is placed across the object and around the display backer. The strip is then secured to itself or the display backer and dried or cured to retain the object. To free the object, the assembly with the display backer is submerged under still water or placed under running water. The strip will break in running water in less than 5 minutes allowing removal of the object (single item or bundle of items) from the backer. The backer may be made of a recyclable material.

### CROSS-REFERENCE TO RELATED APPLICATIONS

This application claims benefit of Canadian patent application number (Unknown), filed Sep. 21, 2010, which is herein incorporated by reference

### FIELD OF THE INVENTION

The invention relates to packaging methods, and more particularly relates to methods of strapping an object to display backer in packaging and unstrapping the object for use.

### BACKGROUND OF THE INVENTION

Many consumer products are packaged in clear front display boxes, in which the products are arrayed so that the consumer can easily see the individual pieces, and how they might be assembled or used together. To facilitate viewing, the objects are frequently strapped to a display backer inside the box using tape, strings, wire twist ties, elastic bands, or rigid cable ties (and very often, combinations of these strapping methods).

The problem with each of these methods of strapping is that they require extensive “fiddling” with the ties/straps to remove the object, which delays the gratification of assembling or using the product and causes consumer frustration. The ties may be nearly invisible (e.g. some tapes and fine strings or elastics), which adds to the difficulty in removing them by cutting or untying them. In the case of wire or cable ties, the consumer can also cause injury to him/herself or the object as he struggles to cut the tie/strap with a knife, box cutter or scissors.

There is also an environmental toll of each of these methods, as they create a pile of garbage in the form of pieces of non-biodegradable strap. They also prevent easy recycling of the display backer, as bits of the straps (typically non-recyclable materials) may continue to be attached or adhered to the backer (which would otherwise be recyclable).

It would be advantageous to provide a method of strapping objects to a display backer that would permit easy removal of the object from the backer, without the environmental downsides of the known methods.

### SUMMARY OF THE INVENTION

According to a first aspect of the invention, a method is provided for attaching an object to a display backer. The object is placed against a first side of the display backer. A wet or uncured strip of soluble polyvinyl alcohol film (PVA) is then threaded across the object and around at least a portion of the backer (or through slots in the backer). The strip is secured on a second side of the display backer sufficiently tightly to retain the object on the first side thereof (e.g. the strip may be tied/knotted or overlapped to make a loop with or without first pulling/stretching the strip, or the strip may be attached directly to the backer). The strip is then allowed to dry or cure (usually less than about 10 minutes). The dried or cured PVA strip is soluble in water such that the strip breaks in running water in less than about 5 minutes to free the object (depending on the thickness and width of the strip).

The object can be a single item or a bundle of items. In one example, the bundle of items can be a bundle of like items (e.g. nested or grouped together as a bundle).

The PVA may be provided in the form of a roll or sheet, in which case it may need to be cut or punched out into strips prior to use. The PVA may also be provided in the form of a loop, in which case it may need to be cut across one side to form a strip prior to use.

According to a second aspect of the invention, a method is provided for removing an object from a display backer, the object being attached to the display backer by at least one soluble PVA strip. The object and the display backer are placed into water to soak the at least one PVA strip. The strip is allowed to dissolve in the water until the strip breaks away from the object (the strip breaking in less than about 5 minutes when exposed to water). The object is removed from the display backer, and the display backer is discarded. If there is any PVA residue on the object or the display backer, this may be simply rinsed away.

To dissolve the PVA, the object and display backer may be placed under running water (which is particularly directed at the PVA strip). The higher the pressure and greater the volume of water, the faster the strip will dissolve. Alternatively, the object and display backer may be simply submerged in a bath of still water (e.g. in a kitchen sink), although using this passive method, the PVA strips may take longer to dissolve.

Preferably, the display backer is made of a recyclable or reuseable material (e.g. cardboard, recyclable plastic, metal, glass, textile). Various backer materials are possible but for cost, convenience, strength and recyclability, cardboard may be preferred. Cardboard also does not readily break down in short exposure to water.

According to a third aspect of the invention, an assembly is provided, comprising an object and a display backer, the object being harnessed to the display backer with at least one strip of soluble PVA. The object is positioned against a first side of the display backer. The display backer preferably has slots proximate to the object. The strip of PVA runs across the object and through the slots (or simply around the entire backer). The strip is secured on the second side of the display backer (strip ends being secured to each other or to the display backer) to retain the object. The PVA strip is soluble in water such that the strip breaks in running water in less than 5 minutes to free the object.

### BRIEF DESCRIPTION OF THE FIGURES

FIG. 1 is a flow chart of the method of attaching an object to a display backer.

FIG. 2 is a flow chart of the method of removing an object from a display backer.

FIG. 3 is a perspective front view of a looped strip of soluble PVA.

FIG. 4 is a front view of a bundle of objects (in this case, forks) being held together with a loop of soluble PVA.

FIG. 5 is a front view of the bundle of forks attached by a PVA strip to a display backer.

FIG. 6 is a front view of the forks attached to display backer inside a display box with clear front.

FIG. 7 is a back view of a PVA strip attached by overlapping two ends.

FIG. 8 is a back view of a PVA strip attached by tying the two ends into a knot/bow.

FIG. 9 is a front view of a different object (i.e. child's plastic toy) held against a display backer with PVA strips.

FIG. 10 is a front view of a different object (i.e. wine glass) held against a display backer with PVA strips.

FIGS. 11A-11C show the process for removing a series of bundles of flatware from a cardboard backer by dissolving the PVA strips under running water in a sink.

### DETAILED DESCRIPTION

A strip of PVA film is cut or punched from a roll or large sheet. Alternatively, uncured PVA is partially cured into a malleable strip. One useful PVA film for this purpose is available from Monosol under the trademark M7031™, although there are many similar products on the market. The PVA film is normally clear or translucent. A colored (transparent or opaque) PVA film could also be used.

Preferred thickness for the PVA film is around 3.0 Mil. Less than 3.0 Mil is possibly too flimsy for most uses, while more than 4.0 Mil is possibly too thick to readily dissolve under normal use.

Various widths and lengths of strips are possible (clearly dependent on the nature of the article to be secured and the size of the article portion). Longer lengths are also needed if the strips are to be tied instead of overlapped or abutted. In general, the strips should have approximately similar dimensions to the tape/string/cable that would otherwise have been used for strapping the article to the backer, as it is generally preferred for the strips to “disappear” and the object alone to be highlighted in the display.

In general, less volume of strip means less to dissolve. The strips are preferred over a generalized film or bag covering the backer, which results in a goopy mess when exposed to water.

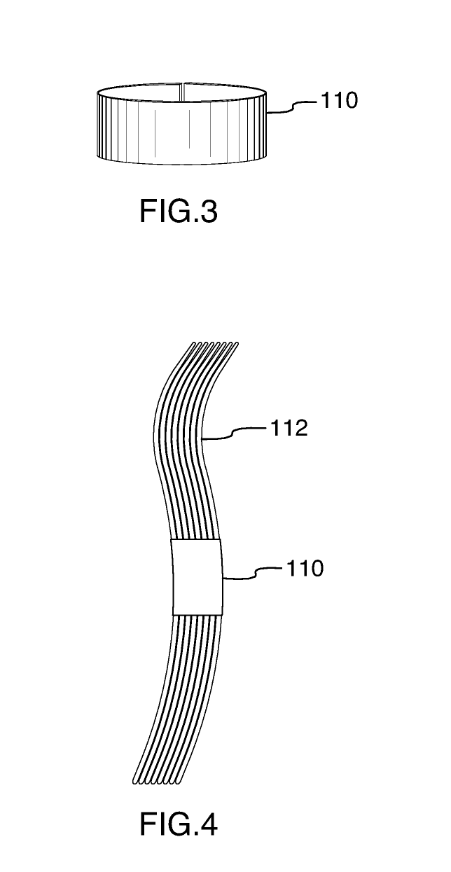

FIG. 3 shows a loop made of a thin PVA strip 110. The strip 110 of PVA film can be looped around an object or bundle of items 120, as shown in FIG. 4.

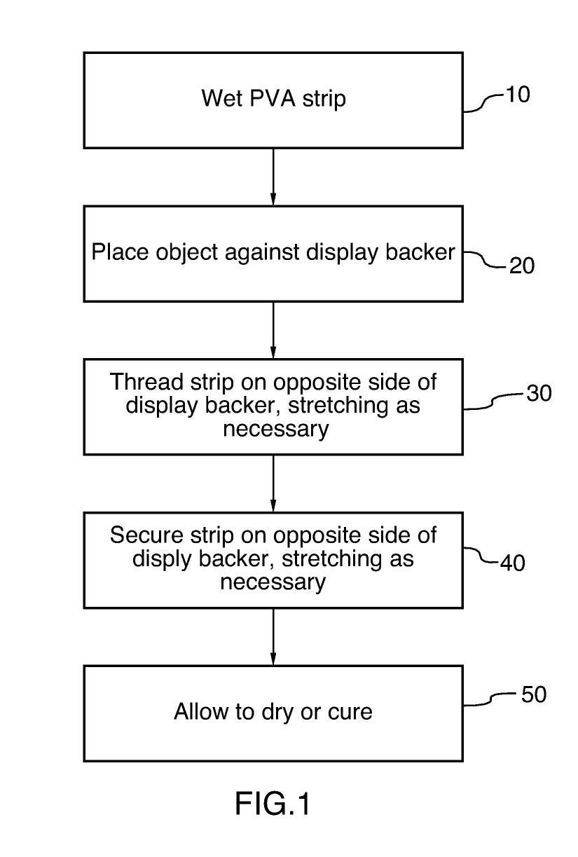

A method for attaching objects to a display backer using these PVA film strips is laid out in FIG. 1. The PVA strip is used in uncured or partially cured state, or else it is wet after curing to allow it to be manipulated and reshaped 10. The term “wet” will be used herein interchangeably to refer to either uncured/partially cured, or cured then re-wetted, PVA. The term “strip” is not limited to a solid material. The strip may be applied in a liquid or partially gelled form like an adhesive.

To attach an object to a display backer using this wet PVA strip the object is first placed against the display backer 20 (near holes or slots in the backer). The wet strip is then placed across the object and each end of the strip threaded through the backer, stretching the strip as necessary to conform the wet strip to the contour of the article, pinning it securely against the display backer. On the reverse side of the backer, the strip is then secured (to itself or to the backer directly). Once the strip is dried or cured 50, the object will stay on the display backer securely.

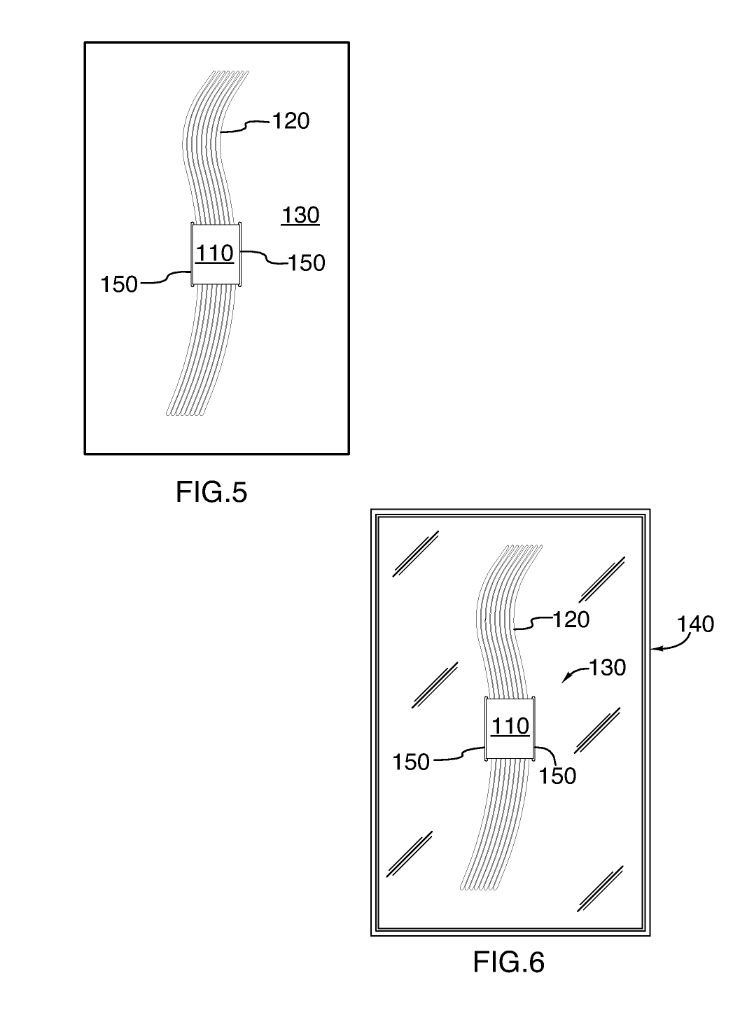

A display backer 130 having (previously die-cut or formed) holes/slots 150 is used as the substrate for the object 130, as shown in FIG. 5. The PVA strip 110 can then be positioned over/across the object (or bundle of items) to retain the object 120 against the backer 130. Once the strips are dried/cured, this assembly can then be put into a clear front display box 140, as shown in FIG. 6. Alternatively, the PVA strip may simply be positioned around the objects and backer without recourse to slots. Or, a very long strip could be threaded in and out through multiple slots and secured (to itself or the backer) on the front or back side of the backer to hold multiple objects.

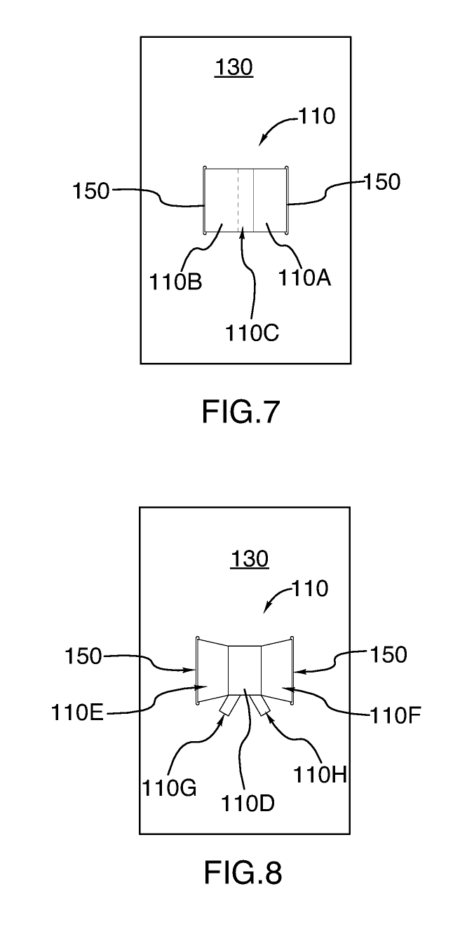

FIGS. 7 and 8 show two variations for joining the strip to itself on the reverse (or second) side of the display backer. As shown in FIG. 7, the strip can simply be overlapped onto itself (i.e. two sides 110A, 1108 pulled together and their ends overlapped and sealed to each other to form a joint 110C). As shown in FIG. 8, the strip can be tied in a knot (or bow). The two sides 110E, 110F of the strip can be pulled together (stretching the strip, as necessary). A knot 110D is formed and the loose ends of the strip 110G, 110H are pushed down to lie flat against the backer 130. (In the wet state, the ends of the strip will stick to the backer.)

Alternatively, it will be appreciated that the ends could simply be butted together with only their ends touching to seal the loop. Or, the strip could be adhered to the backer directly (not shown). PVA has naturally adhesive properties, which lends it to this application in particular. The wet PVA sticks slightly to the object and to the backer, but does not tend to leave a mark or stain, or pick up surface paint or coating from the object under normal conditions.

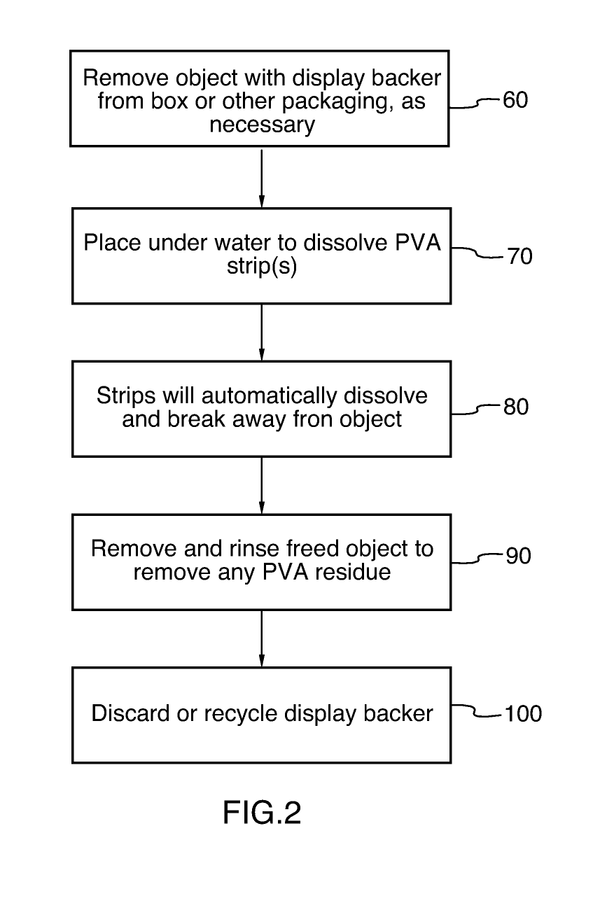

The process for removing the object is set out in FIG. 2. The object together with its display backer is removed from its box or other packaging, as necessary 60. The assembled object and display backer are placed in water to dissolve the PVA strips 70. The strips automatically dissolve in the presence of water and allow the object to break away from the display backer 80. The freed object can then be removed from the backer 90 and the display backer recycled or discarded 110.

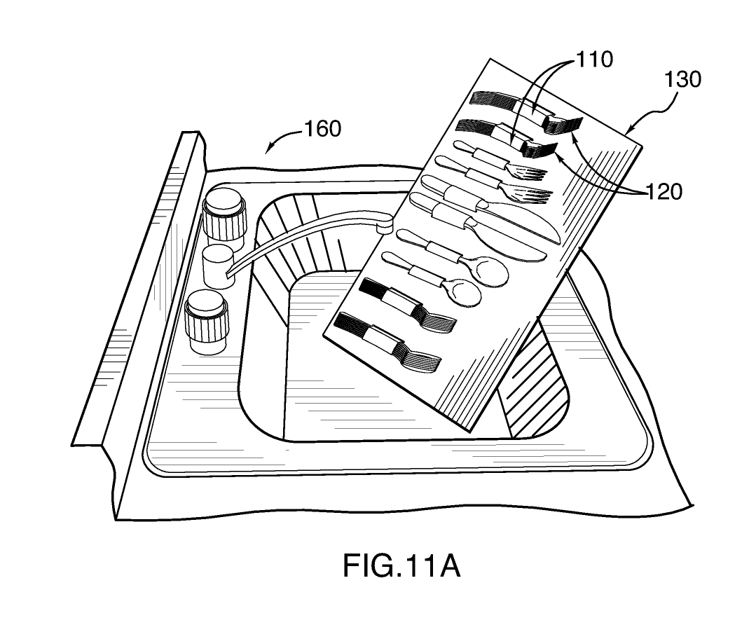

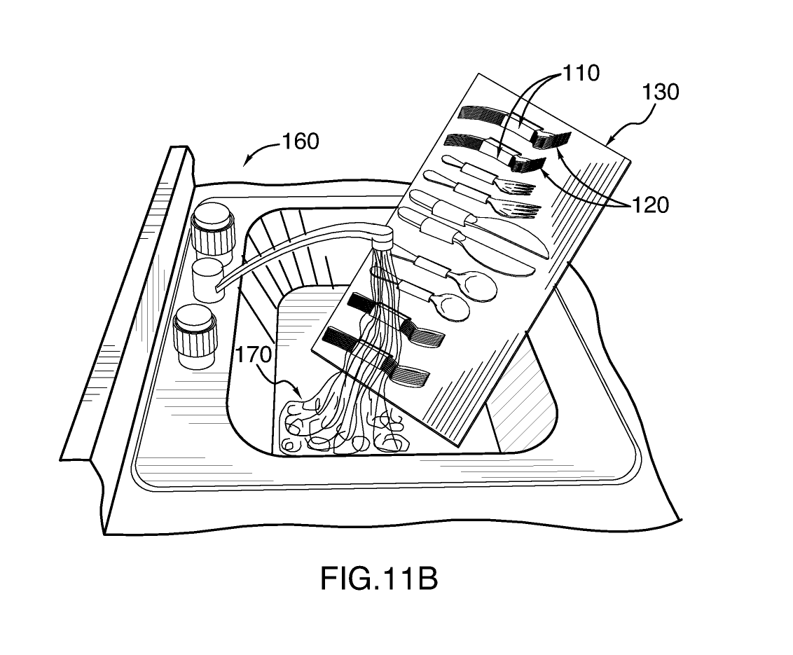

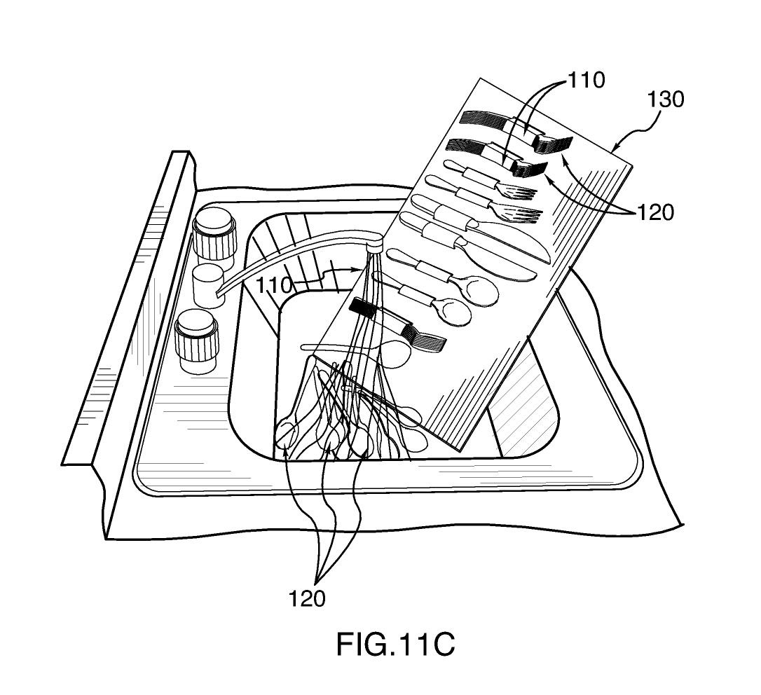

The process is shown graphically in FIGS. 11A-11C. Starting from a display backer 130 holding a number of objects 120 (in this case bundles of flatware) with PVA strips 110, the backer 130 is held under running water 170 to expose the strips to the water 170. These strips 110 dissolve into the running water 170 (draining away safely into municipal water collection). As shown in FIG. 11C, with the strips dissolved, the objects 120 simply fall away from the backer into the sink 160. The objects 120 are freed without the need to cut or untie the strips 110 manually.

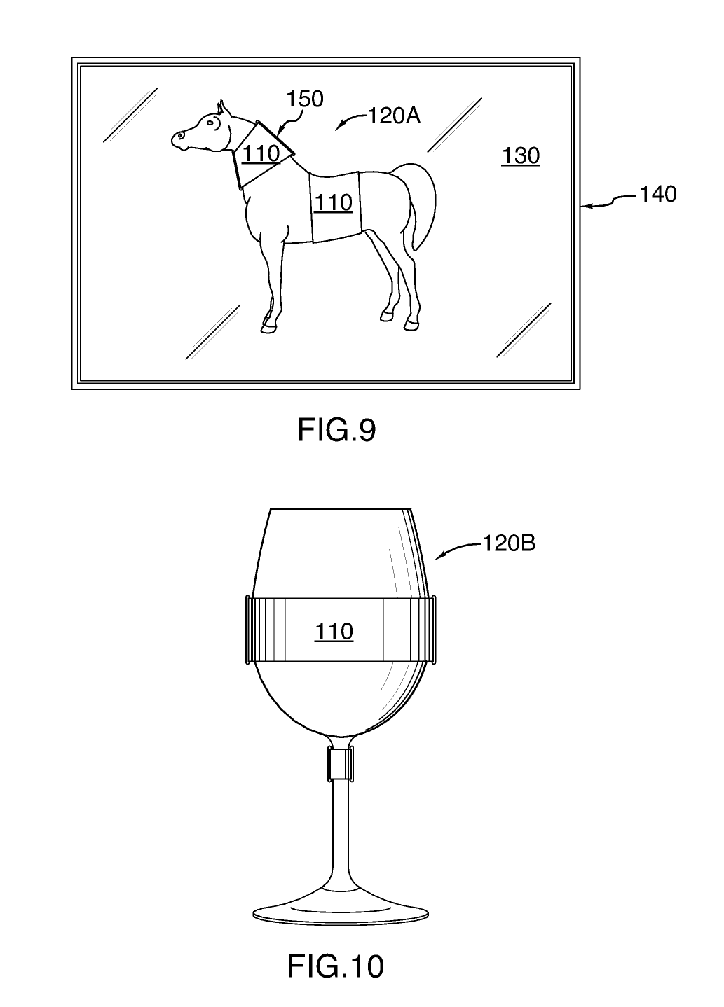

The PVA strips 110 are useful as strapping for many types of consumer products that are commonly displayed in clear front display boxes 140. They have been found effective for even relatively heavy goods such as flatware bundles and objects with complex shapes and contours (like the toy horse 120A shown in FIG. 9). For more delicate objects, such as the wine glass 120B shown in FIG. 10, it may be preferred to immerse the object and backer into a bath of still water rather than holding the assembly under running water. The strips break rapidly (typically within seconds), especially in the presence of running water, and the object can become freed and roll away from the backer before the user is ready to catch it.

The PVA strips may be particularly advantageous for certain delicate objects as the strips do not cut into, dent or scratch the object or the backer or apply excessive pressure in one spot, unlike cable ties, elastics, strings or wires. Instead, the strips simply conform to the object and retain it gently. This also avoids the need for separate pressure-balancing or guide pieces on the reverse side of the backer (or tape to hold down the ends of the wires or twist ties).

The PVA strips are useful for products that can be safely exposed to water (examples include many housewares, toys, tools, etc.). The PVA allows the object to be easily accessed when exposed to a bath of water but the strips will not tend to break or weaken under normal conditions and regular handling and shipping (even in moderate atmospheric humidity).

Because the PVA strips are not reinforced with any other material (e.g. threads or fibers), they also dissolve cleanly in water and the resulting solution can be drained away without creating more mess. The backer is also left clean and re-useable or recyclable without the need to remove other bits of string or filament. Cardboard, plastic, metal, glass or textile backers are possible. These materials are recyclable in many jurisdictions provided they are free from other non-recyclable matter.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

What is claimed is:

1. A method of removably attaching an object to a display backer, comprising:
a. placing the object against a first side of the display backer;
b. threading a wet or uncured strip of soluble PVA across the object and around at least a portion of the display backer;
c. securing the strip on a second side of the display backer sufficiently tightly to retain the object on the first side thereof; and
d. allowing the strip to dry or cure;
wherein the dried or cured strip is soluble in water such that the strip breaks in running water in less than 5 minutes to free the object.

2. The method of claim 1, wherein the backer has slots, and wherein the object is positioned on the first side of the display backer proximate to the slots, the strip being threaded through the slots to retain the object.

3. The method of claim 1, wherein the object is a bundle of items.

4. The method of claim 1, wherein the object is a bundle of like items.

5. The method of claim 1, wherein the securing in step (c) comprises attaching the strip to itself on the second side.

6. The method of claim 1, wherein the securing in step (c) comprises attaching the strip to the display backer.

7. The method of claim 1, wherein step (b) further comprises cutting a loop of soluble PVA across one side to make a strip.

8. The method of claim 1, wherein step (c) further comprises pulling the ends of the strip to stretch the strip prior to securing the ends.

9. The method of claim 1, wherein the dry or cure time is less than 10 minutes.

10. A method of removing an object attached by at least one soluble PVA strip to a display backer from the display backer, comprising:
a. placing the object and the display backer into water to soak the at least one PVA strip;
b. allowing the at least one strip to dissolve in the water until the strip breaks away from the object;
c. removing the object from the display backer and discarding the display backer;
wherein the at least one strip is soluble in water such that the strip breaks in running water in less than 5 minutes.

11. The method of claim 10, wherein step (c) further comprises rinsing any PVA residue from the object.

12. The method of claim 10, wherein step (a) comprises placing the object and display backer under running water.

13. The method of claim 12, wherein the running water is particularly directed at the PVA strips.

14. The method of claim 10, wherein step (c) further comprises rinsing any PVA residue from the display backer.

15. The method of claim 10, wherein the display backer is made of a recyclable material.

16. The method of claim 10, wherein the display backer is cardboard.

17. An assembly, comprising:
a. an object;
b. a display backer, the object being positioned against a first side of the display backer;
c. at least one strip of soluble PVA running across the object and around at least a portion of the display backer, the at least one strip being secured to itself or to the display backer on a second side of the display backer to retain the object against the display backer;
wherein the at least one strip is soluble in water such that the strip breaks in running water in less than 5 minutes to free the object.

18. The assembly of claim 17, wherein the backer has slots, and wherein the object is positioned on the first side of the display backer proximate to the slots, the strip being threaded through the slots to retain the object

19. The assembly of claim 17, wherein the object is a bundle of items.

20. The assembly of claim 17, wherein the object is a bundle of like items.

21. The assembly of claim 17, wherein the display backer is made of a recyclable material.

22. The assembly of claim 17, wherein the display backer is cardboard.
